(19) United States
(12) Patent Application Publication
(10) Pub. No.: US 2025/0318545 A1
(43) Pub. Date: Oct. 16, 2025

(54) Frozen Dessert Pump Assembly

(71) Applicant: Plum Creek Farm LLC, Bernville, PA (US)

(72) Inventor: Keith Zimmerman, Leesport, PA (US)

(21) Appl. No.: 19/249,726

(22) Filed: Jun. 25, 2025

Related U.S. Application Data
(63) Continuation-in-part of application No. 18/376,167, filed on Oct. 3, 2023, now Pat. No. 12,366,238.
(60) Provisional application No. 63/491,378, filed on Mar. 21, 2023.

(51) Int. Cl. A23G 9/20; A23G 9/08; A23G 9/22; F04B 43/073

(52) U.S. Cl. CPC A23G 9/20; A23G 9/08; A23G 9/228; F04B 43/073

(57) ABSTRACT

A pump assembly for delivering liquid dessert to the freezing chamber of a soft serve machine where it is formed into frozen dessert. The pump includes a reciprocating diaphragm pump, an overrun unit, pressure chamber and control unit. The overrun unit is charged with pressurized air from an external pressure source. The pressure chamber receives liquid dessert from the pump, combines the liquid dessert with pressurized air from the overrun unit, and delivers the liquid dessert to the freezing chamber of an ice cream machine. The pump assembly is configured so that the pressure and of the air, and the volume of air delivered by the overrun unit to the pressure chamber per stroke of the pump is constant over the operating range of dispense rates of frozen dessert from an associated freezing chamber.

### CROSS REFERENCE TO RELATED APPLICATIONS

This application is a continuing application of U.S. nonprovisional patent application Ser. No. 18/376,167, filed Oct. 3, 2023, which claims the benefit of U.S. provisional patent appln. No. 63/491,378, filed Mar. 21, 2023, the contents of which are incorporated herein by reference.

### FIELD OF THE INVENTION

The present invention relates to frozen dessert machines. More particularly, the invention relates to pump assemblies utilized with frozen dessert machines.

### BACKGROUND OF THE INVENTION

In the production of soft serve ice cream and other frozen dessert products, a mixture packet of ingredients is combined with water to form a slurry (“liquid mix”), which is stored in a reservoir of the machine. The liquid mix is then normally combined with a non-toxic gas, such as air, and frozen in order to produce a tasteful, palatable and profitable end product (“frozen dessert”). For soft serve ice cream, the air content can vary from 0% to 60% of the total volume of the ice cream. The amount of air alters the taste of the frozen dessert. Product with a low quantity of air has a heavy, icy taste while product with a high quantity of air tastes creamier, smoother and lighter. The optimum quantity of air is determined by the other ingredients and individual taste. In general, the preferred air content is between 30% and 45% of volume.

The liquid mix is stored at an ideal temperature in a reservoir (stainless steel or other material) that is refrigerated and controlled by a thermostat. The liquid mix is stored in the reservoir until it is delivered by means of gravity or a pump into a freezing chamber where it is intimately mixed with the targeted quantity of air, stirred, and quickly frozen to obtain the soft frozen dessert.

An important reason for a frozen dessert machine to have a pump is to increase the volume of the frozen dessert by adding air to the liquid mix. This affects the product in two ways: First, it reduces the amount of liquid mix in a given volume of the ice cream, which increases the output of the machine per hour; and, secondly, it decreases the density of the frozen dessert, and thus increases the frozen dessert's “softness” creating a sensation that it is less cold to the palate.

In many prior art frozen dessert machines, the operator can vary the dispense rate of the frozen dessert into the receptacle such as a cup or cone. Typically, the operator dispenses the dessert slowly at first, then more rapidly to fill the receptacle, and then slowly again to “top off” the cone or cup. Under ideal working conditions, the pump should deliver a constant, perfect supply of liquid mix and air to the freezing chamber in a predetermined ratio between air and liquid mix no matter how fast or slow the dispense rate. However, typical prior art pumps run at a fixed speed and are triggered by a switch when the user pulls the draw handle. The pump may be pumping more or less product than what the operator requires. If the operator is dispensing slowly, the excess liquid and air are dumped back into the liquid mix hopper via a pressure relief valve, which creates foam. If the operator is dispensing quickly and faster than the pump is pumping, the freezing chamber pressure drops and creates air pockets because the pump cannot keep up. Both of these situations are undesirable. Therefore, it would be desirable to provide a pumping assembly for a frozen dessert machine that delivers air into the liquid mix at a constant pressure as the pump cycles at variable speeds.

### SUMMARY OF THE INVENTION

The present invention relates to a pump assembly used on a frozen dessert machine to inject air into liquid mix to create liquid dessert, and then deliver the liquid dessert to the freezing chamber of the machine where it is formed into frozen dessert such as soft serve ice cream. The pump assembly generally comprises a diaphragm pump, an overrun unit, a pressure chamber, and a control unit. Upstream, the pump assembly is connected to an air pressure source. Downstream, the pump assembly is connected to the freezing chamber of an associated frozen dessert machine. In preferred embodiments, the pump is actuated when frozen dessert is dispensed from the associated freezing chamber.

The diaphragm pump has a housing, an internal chamber, and a reciprocating diaphragm assembly including a diaphragm extending across the internal chamber. The diaphragm divides the internal chamber into a gas chamber on a first side of the diaphragm and a liquid mix receiving chamber on a second, opposite side of the diaphragm.

The overrun unit is configured to receive pressurized air from an external pressure source such as a compressor or compressed air tank. In some preferred embodiments, the overrun adjustment chamber has an adjustable volume. Preferably, the volume of the overrun adjustment chamber can be adjusted during operation of the diaphragm pump.

The pressure chamber receives liquid mix from the receiving chamber, combines the liquid mix with pressurized air received from the overrun unit to form liquid dessert, and then delivers the liquid dessert to the freezing chamber. Preferably, the pressure chamber is defined within a pressure housing that is releasably attached to the diaphragm pump.

The control unit has a fluid communications network that selectively connects the external source of pressurized air in fluid communication with the overrun unit, selectively connects the overrun unit in fluid communication with the gas chamber, selectively vents the air in the gas chamber to atmosphere, and selectively connects the overrun unit to the pressure chamber. The control unit is configured to receive gas of a desired pressure from a compressor in combination with a pressure regulator.

Reciprocation of the diaphragm assembly is caused by alternately pressurizing the gas chamber with air from the overrun unit, and then venting the air from the gas chamber to atmosphere. On the diaphragm assembly upstroke, liquid mix is drawn into the receiving chamber from a reservoir. On the diaphragm assembly downstroke, liquid mix is expelled from the receiving chamber into the pressure chamber and pressurized air is expelled from the overrun unit into the pressure chamber to form liquid dessert in the pressure chamber.

In one preferred embodiment of the invention, the pump assembly is configured so that the volume of pressurized air delivered to the pressure chamber per stroke of the pump is constant over the operating range of dispense rates of frozen dessert from an associated freezing chamber. The pump assembly is also configured so that the overrun chamber supplies air to the pressure chamber at a constant pressure over the operating range of dispense rates of frozen dessert from an associated freezing chamber. As a result, the pressure within an associated freezing chamber is automatically maintained without the use of a freezing chamber pressure sensor or pressure relief valve.

In preferred embodiments, the speed of the pump automatically adjusts to maintain a constant freezing chamber pressure regardless of the dispense rate of frozen dessert from an associated freezing chamber. Preferably, the speed of the pump is controlled by the dispense rate of frozen dessert from the associated freezing chamber.

In preferred embodiments, the pump assembly includes a plurality of one-way valves that regulate fluid flow of air, liquid mix, liquid dessert, and frozen dessert. A valve permits only one-way fluid communication from the overrun unit to the pressure chamber. A valve permits only one-way fluid communication from the receiving chamber to the pressure chamber. A valve permits only one-way fluid communication from a liquid mix reservoir to the receiving chamber. In some preferred embodiments, the valves comprise a flexible, one-way valve having a duckbill configuration.

The diaphragm assembly preferably operates between a home position and extended limit position. A spring within the pump urges the diaphragm assembly to the home position. The diaphragm assembly oscillates to the extended position and back to the home position by alternately pressurizing the gas chamber with air from the overrun unit, and then venting the air from the gas chamber to atmosphere. In preferred embodiments, the volume of the gas chamber is minimized and the volume of the receiving chamber is maximized when the diaphragm assembly is located in the home position. In preferred embodiments, the volume of the gas chamber is maximized and the volume of the receiving chamber is minimized when the diaphragm assembly is located in the extended position.

In preferred embodiments, the diaphragm assembly includes a guide assembly comprising a guide stem connected to the diaphragm and a bushing surrounding the guide stem.

The guide assembly oscillates in a cylinder formed in the pump housing. The bushing includes a fluid communication channel that selectively connects with different portions of the fluid communications network of the control unit. A gas passage to and from the gas chamber is defined between the guide stem and the bushing.

### BRIEF DESCRIPTION OF THE DRAWINGS

FIG. 1 is an isometric view of a dual hopper assembly for a frozen dessert machine with one of the hopper covers removed;

FIG. 2 is a fragmentary, enlarged, isometric view of the hopper assembly of FIG. 1 with the pump cover and second hopper cover removed;

FIG. 3 is a side isometric view of a pump assembly in accordance with a preferred embodiment of the invention;

FIG. 4 is another side isometric view of the pump assembly of FIG. 3;

FIG. 5 is a top plan view of the pump assembly of FIG. 3;

FIG. 6 is a cross-sectional view taken along lines A-A of Fig. FIG. 5;

FIG. 7 is a side isometric view of a diaphragm assembly folded downwardly in accordance with a preferred embodiment of the invention;

FIG. 8 is a side isometric view of the diaphragm assembly folded upwardly in accordance with a preferred embodiment of the invention;

FIG. 9 is an exploded perspective of the diaphragm assembly of FIG. 8;

FIG. 10 is a cross-sectional view taken along lines 10-10 of FIG. 12;

FIG. 11 is a bottom plan view of the diaphragm assembly of FIG. 8;

FIG. 12 is a top plan view of the diaphragm assembly of FIG. 8;

FIG. 13 is a fragmentary cross-section of the interface between the upper portion of the guide assembly the top pump housing body;

FIG. 14 is an isometric view of a one-way valve in accordance with an embodiment of the invention;

FIG. 15 is a front elevational view of the one-way valve of FIG. 14;

FIG. 16 is a cross-sectional view taken along lines 16-16 of FIG. 14;

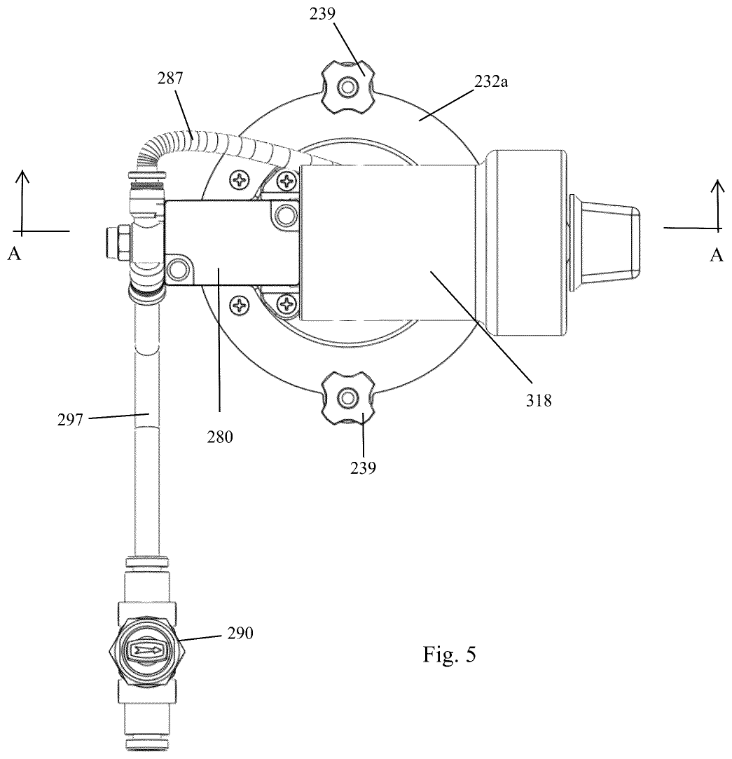

FIG. 15 is a cross-sectional view taken along lines 15-15 of FIG. 5 when the pump cycle is in the home position;

FIG. 17 is a fragmentary cross section showing the overrun unit in more detail;

FIG. 18 is a cross-sectional view taken along lines A-A of FIG. 5 when the pump is in the home position;

FIG. 19 is a cross-sectional view taken along lines A-A of FIG. 5 when the pump is in an intermediate downstroke position;

FIG. 20 is a cross-sectional view taken along lines A-A of FIG. 5 when the pump is in the extended position at the bottom of the downstroke; and,

FIG. 21 is a cross-sectional view taken along lines A-A of FIG. 5 when the pump is in an intermediate upstroke position.

### DETAILED DESCRIPTION OF PREFERRED EMBODIMENTS

In the drawings, like numerals indicate like elements throughout. Certain terminology is used herein for convenience only and is not to be taken as a limitation on the present invention. The following describes preferred embodiments of the present invention. However, it should be understood, based on this disclosure, that the invention is not limited by the preferred embodiments described herein.

As used herein, the term “liquid mix” refers to the slurry of water and ice cream or other frozen dessert mix that is stored in the hopper of the soft-serve machine. The term “liquid dessert” refers to the mixture of pressurized air and the liquid mix that exits the pressure chamber before it reaches the freezing chamber. The term “frozen dessert” refers to the frozen, soft-serve dessert that is dispensed from the freezing chamber of the soft-serve machine. The term “freezing chamber” refers to the container or unit where the liquid dessert is frozen while being churned.

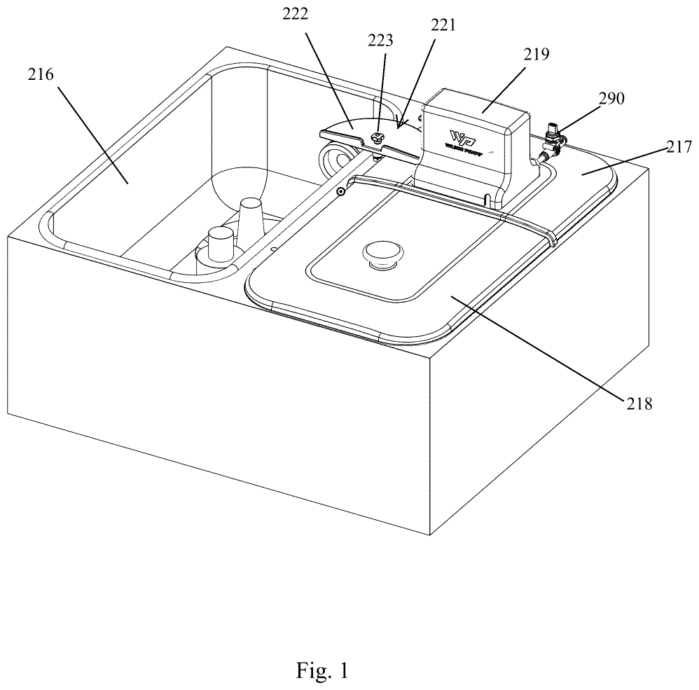

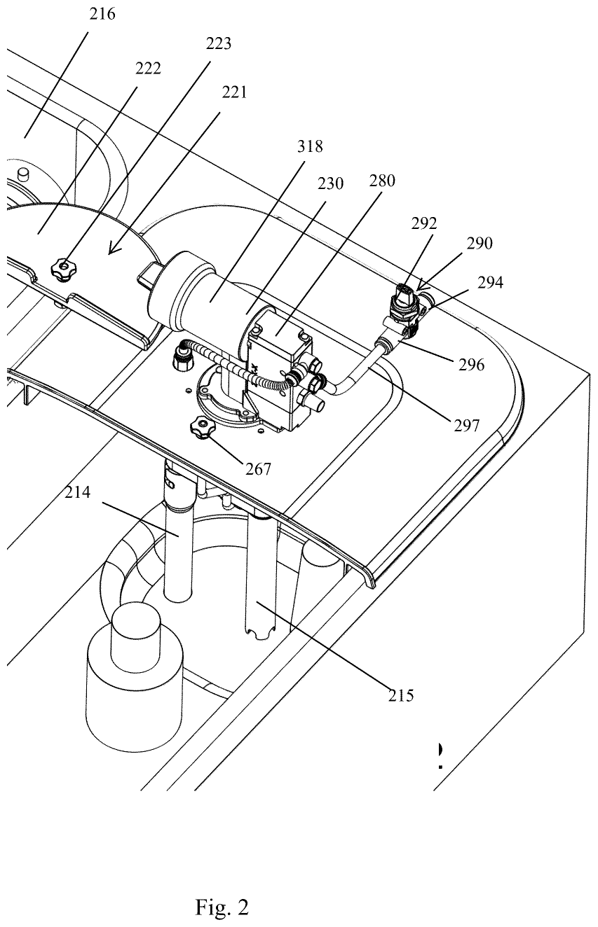

FIGS. 1 and 2 show a double hopper (two flavor) assembly 212 of a frozen dessert machine (not shown) with which the inventive pump assembly may be used. The hopper assembly 212 includes first and second hoppers 216 in which liquid mix is stored. An illustrative soft serve dessert machine generally includes a housing, which supports a freezing chamber (not shown) relative to a respective hopper 216, along with other components for operating the machine. The liquid mix (not shown) is added to the respective hopper 216 and then the hopper cover 218 is placed on the hopper 216. The hopper 216 is configured to maintain the liquid mix at a desired temperature. A pump assembly 230 is mounted on a pump platform 217 with a portion of the pump assembly above the hopper 216 and a portion extending into the hopper 216. The pump assembly 230 is configured to combine the liquid mix with a gas (typically compressed air) to form liquid dessert, and to deliver the liquid dessert to the freezing chamber at a desired pressure. It is understood that the pump assembly 230 may be integrated into the hopper 216 independent of the platform 217.

In one preferred embodiment, the pump platform 217 rests on an elevated lip 220 forming the perimeter of the hopper 216. The lip 220 may include a gasket/seal (not shown) to prevent overflow of the liquid mix out of the hopper 216.

A lock assembly 221 engages the pump platforms 217 to prevent the pump assemblies 230 from dislodging from within the hoppers 216. In the embodiment shown in FIGS. 1-2, the lock assembly comprises a latch 221 and thumb screw 223. In this embodiment, the latch 221 comprises a semi-circular disc. The thumb screw 223 extends through a hole proximate the mid-point of the disc diameter and rotatably fastens to the hopper assembly. When closed, the latch 221 clamps down on the top surface of both hopper covers 218. The latch 221 can be opened by loosening the thumb screw 223 and rotating the latch 221 around the thumb screw to remove its clamping force from one of the pump platforms depending on the direction of rotation of the latch 221.

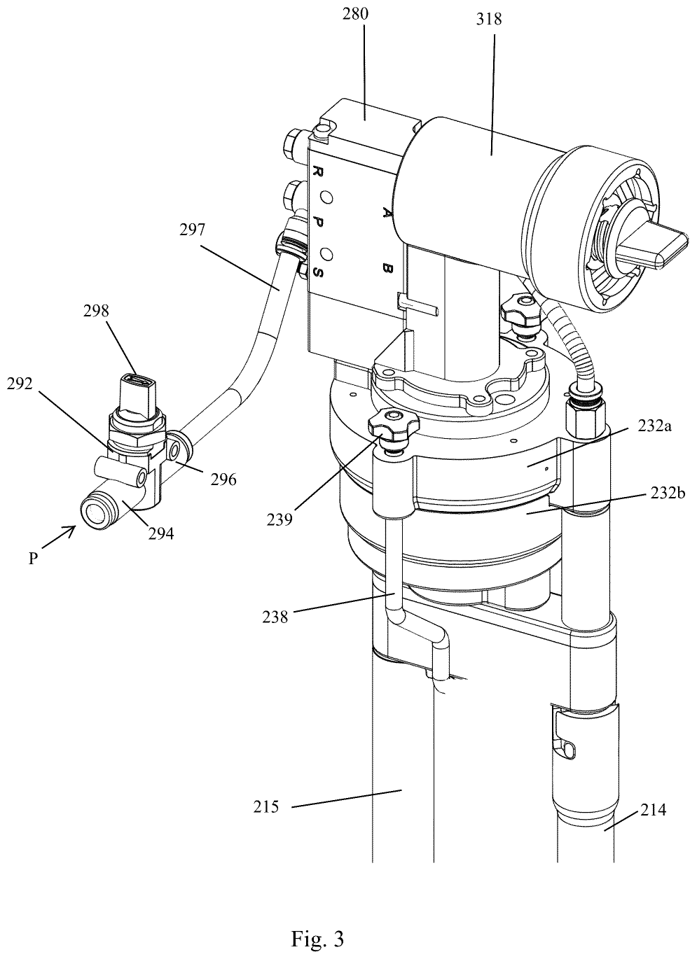

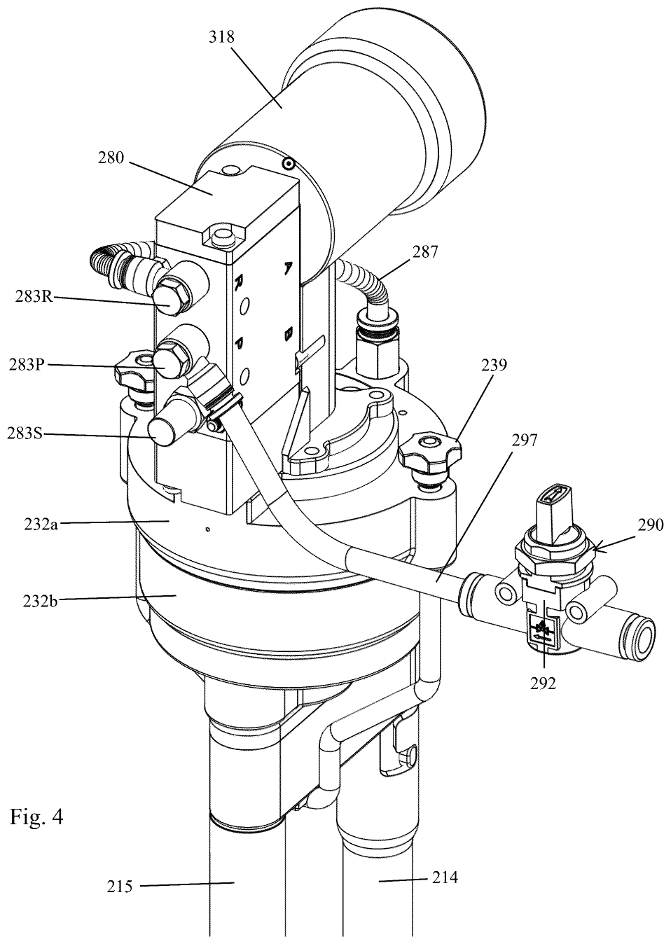

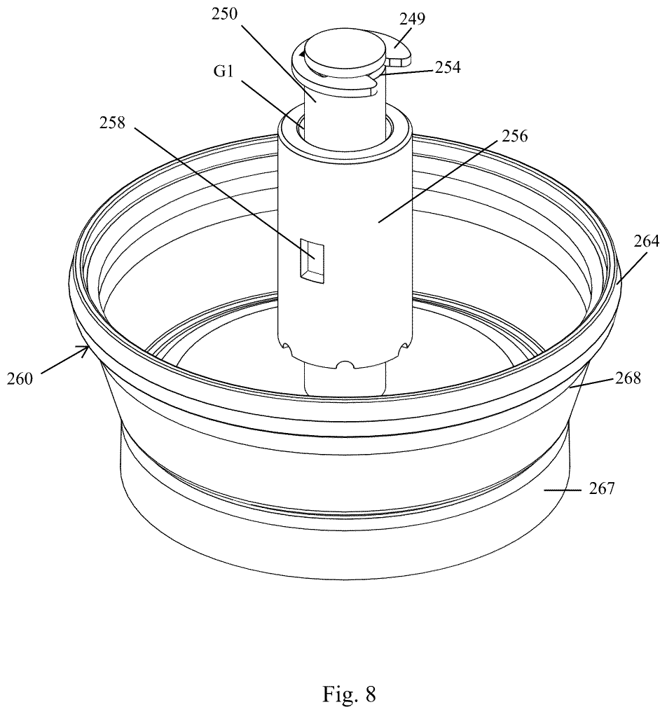

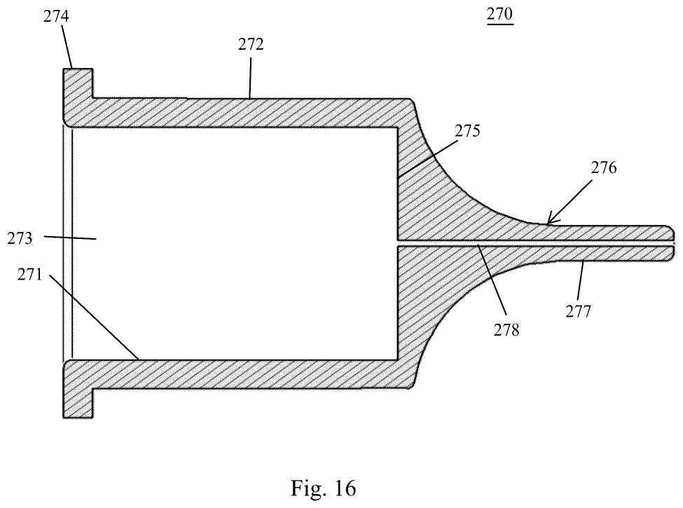

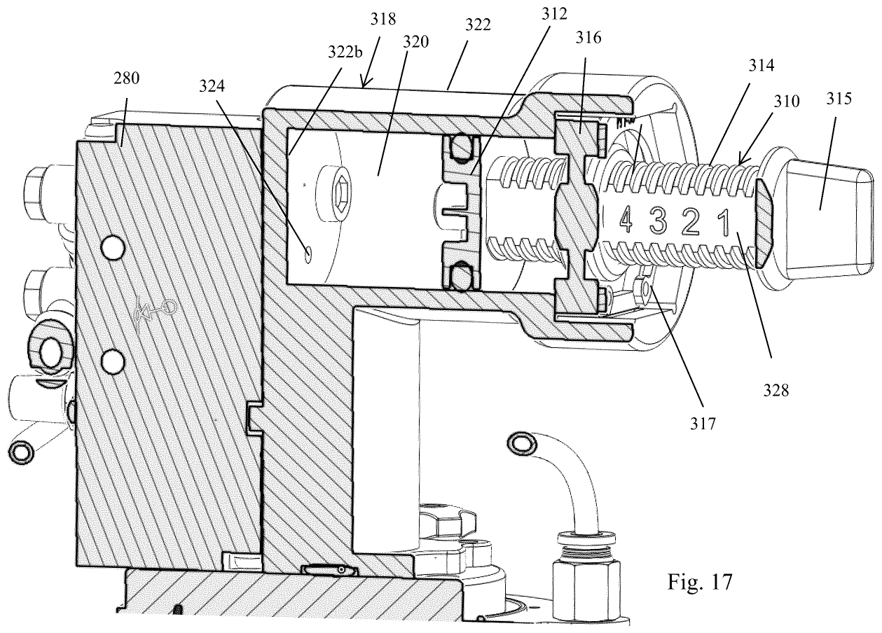

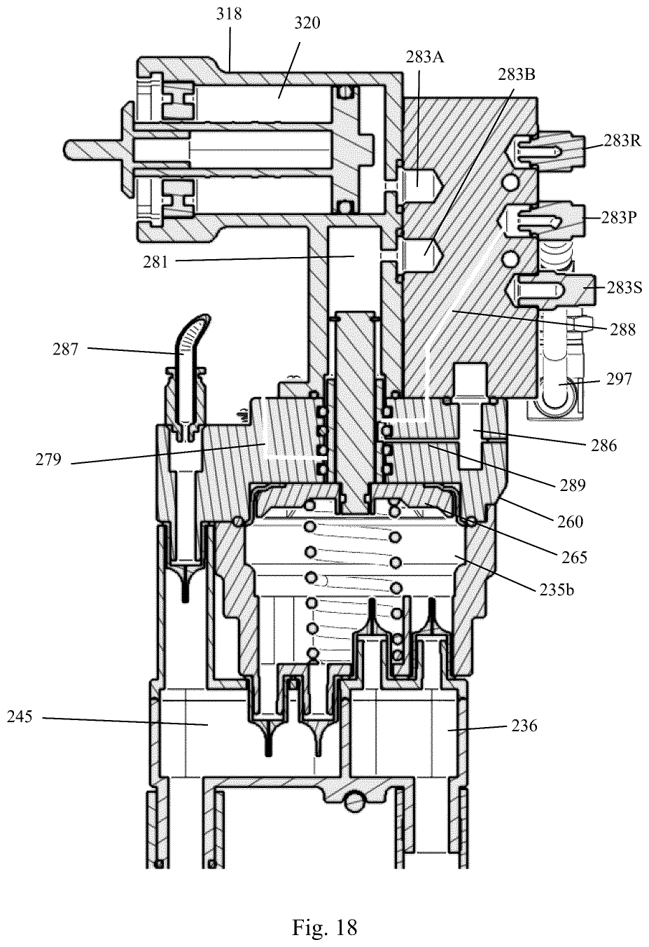

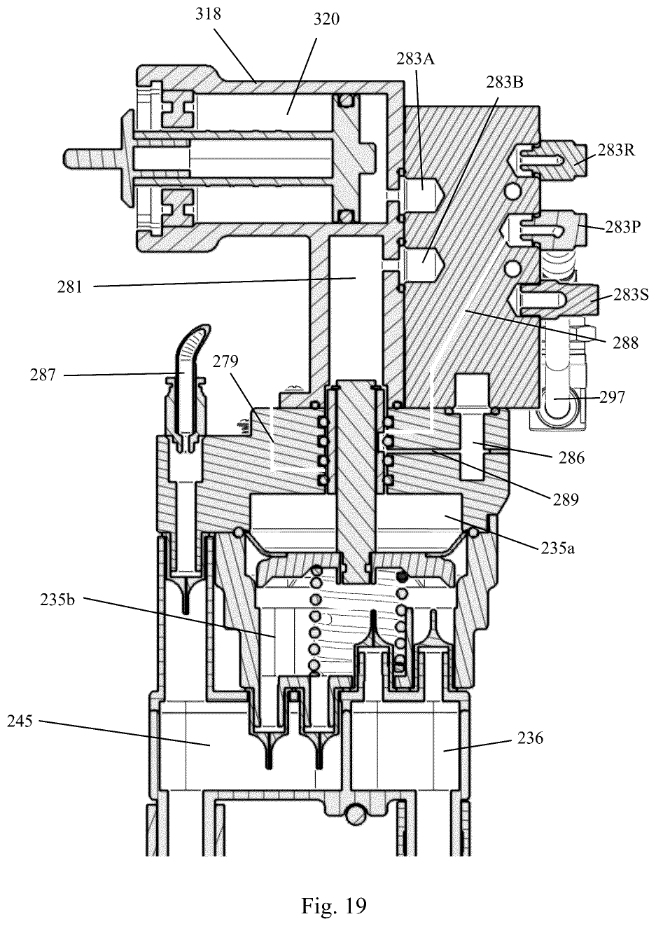

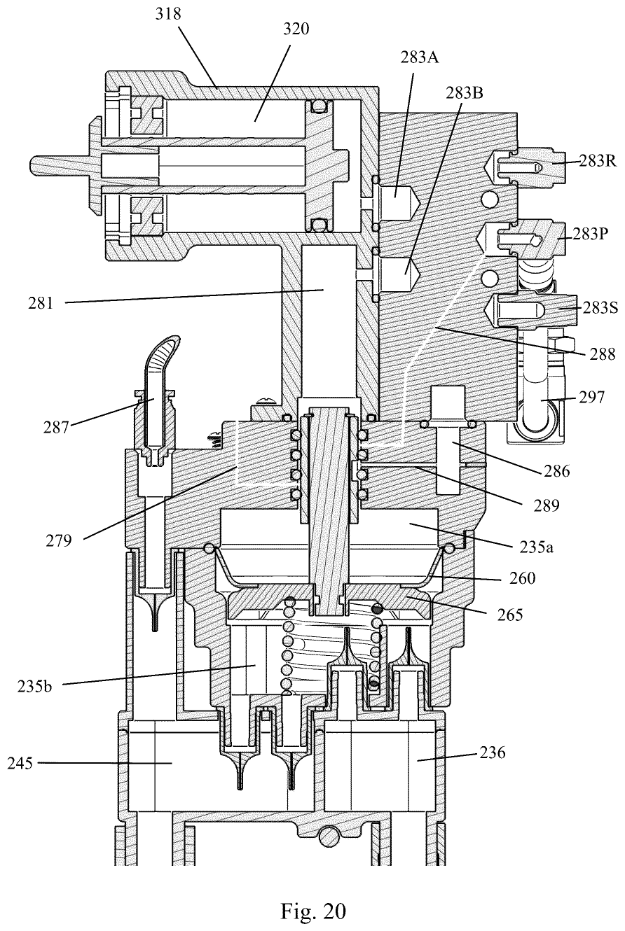

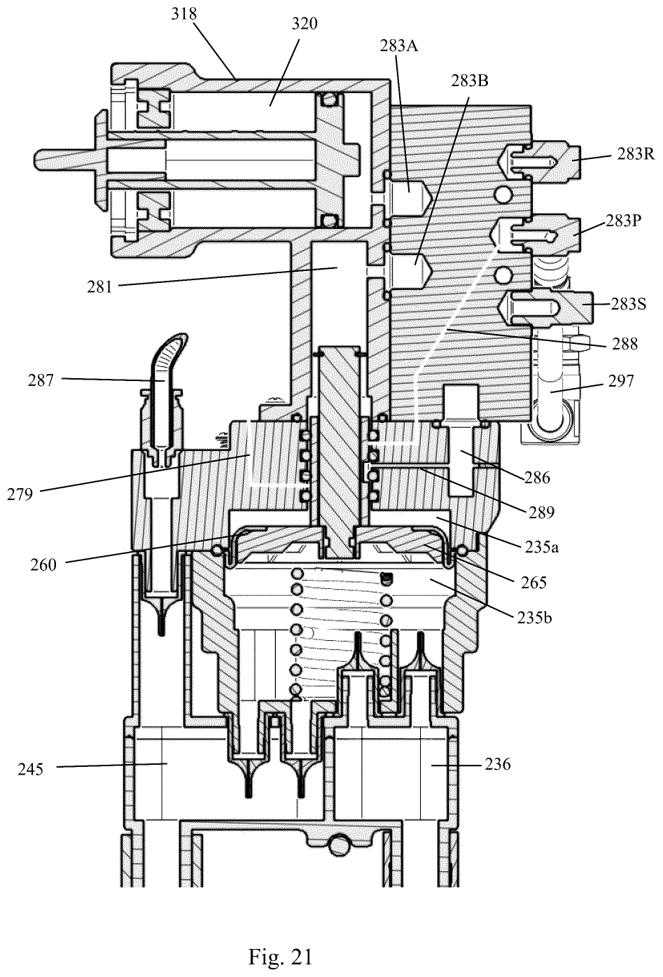

A pump assembly 230 in accordance with a preferred embodiment of the invention is shown in FIGS. 3-21 and is designated generally by reference numeral 230. The pump assembly 230 generally includes a pump 231, an overrun unit 318, a pressure chamber 245, and a control unit comprising a control valve 280 and a fluid communications network of tubes and channels connecting these elements. The control unit selectively connects an external source of pressurized air in fluid communication with the overrun unit, selectively connects the overrun unit in fluid communication with the gas chamber, selectively vents the gas chamber to atmosphere, and selectively connects the overrun unit to the pressure chamber;

In operation, the pump 230 draws liquid mix from one of the hoppers and combines it with controlled amounts of pressurized air in a pressure chamber 245. The liquid dessert then flows to the freezing chamber (not shown) of the soft serve dessert machine where it is stirred, frozen and turned into frozen dessert.

With reference to FIGS. 3-7, the pump 231 includes a pump housing 232 comprised of top 232a and bottom 232b housing bodies, which define an internal chamber 235. The housing bodies 232a, 232b are preferably connected together with clamps 238 or other conventional fastening means along a sealed interface 232c. The clamps 238 may also be utilized to connect the pump assembly 230 to the pump platform 217 such as shown in FIG. 2. Referring to FIGS. 3-5, thumb screws 239 allow the operator to easily and quickly disassembly the pump housing 232 to service and/or clean the internal pump chamber 235.

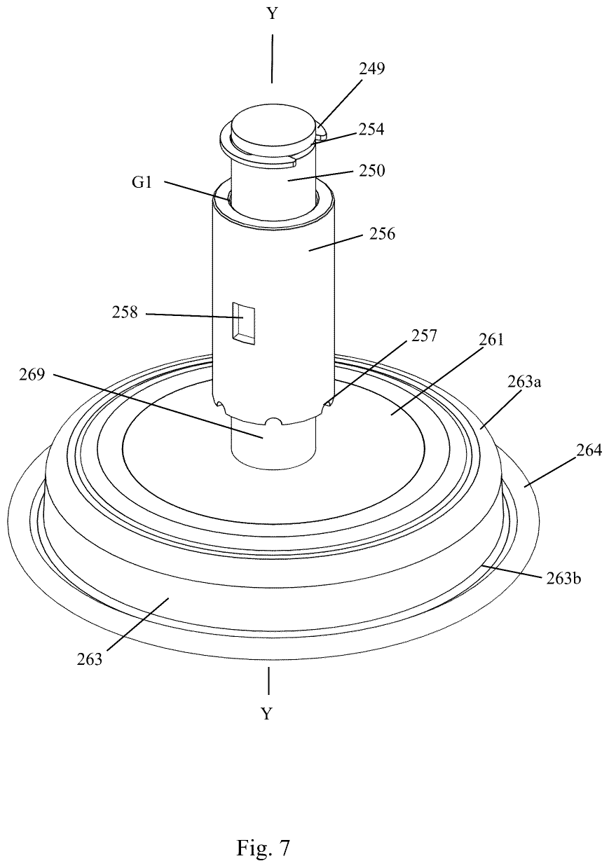

Referring to FIGS. 7-13, a diaphragm assembly 240 is mounted inside the pump chamber 235. The diaphragm assembly 240 includes an elastomeric diaphragm 260 and a diaphragm support 265. The diaphragm 260 is seated in an annular groove defined at the pump housing interface 232c by the top and bottom housing bodies 232a, 232b, and is secured therein by the compressive force between the housing bodies 232a, 232b. The diaphragm 260 extends across the internal chamber 235 and divides the internal chamber into an upper air chamber 235a and a lower liquid mix receiving chamber 235b, as will be described in more detail hereinafter.

Referring to FIGS. 7-12, in one preferred embodiment, the diaphragm 260 has a central, disc-shaped base 261 extending about a central axis “Y”. A co-axial, central passage extends through the base 261. A mounting hub 269 is fixed to the base 261 and surrounds the central passage. The central passage and mounting hub 269 are configured for mounting a guide stem 250, described below.

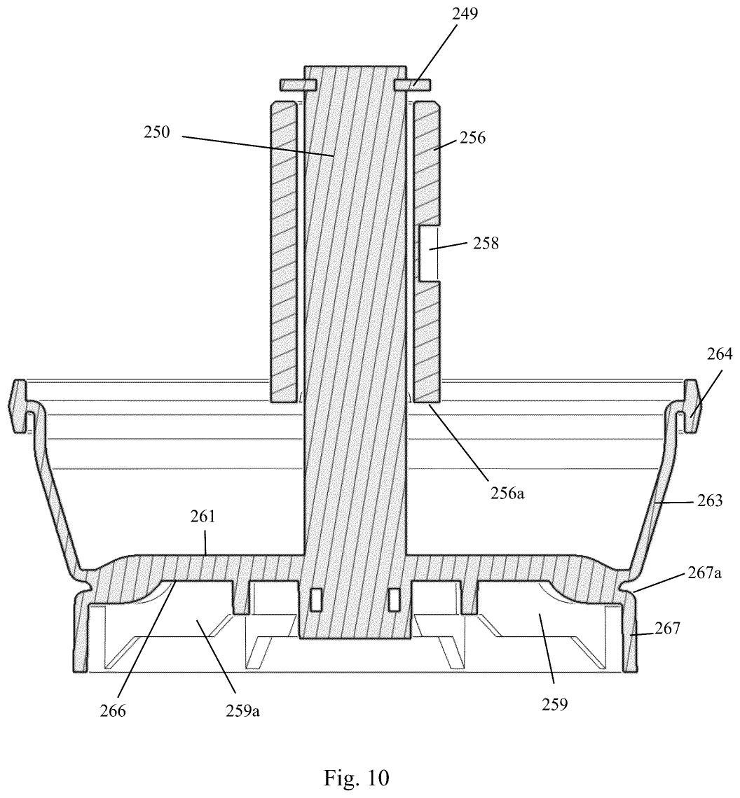

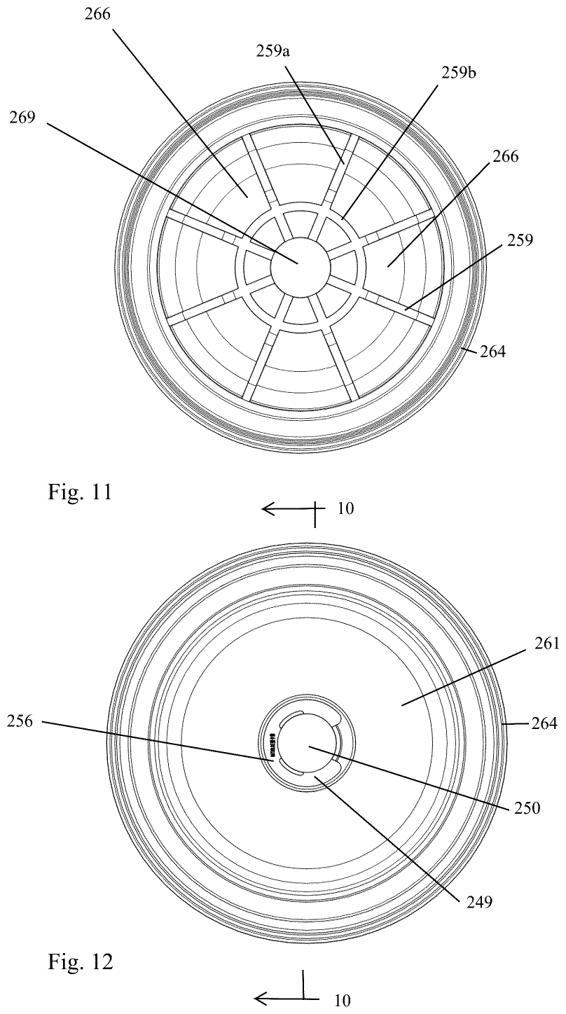

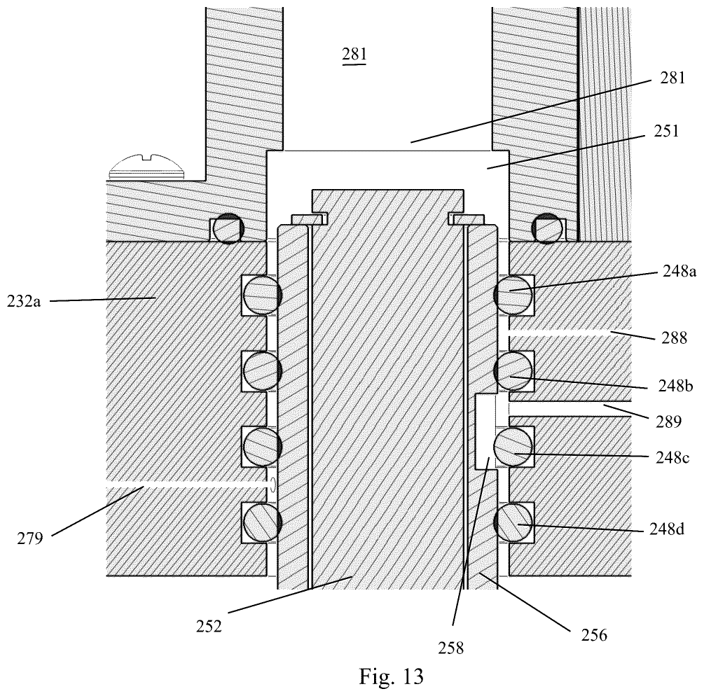

An annular, axially-extending wall 263 is fixed at its proximal edge 263a to the perimeter of the base 261. In one preferred embodiment, the wall 263 has the shape of an endless ribbon and also extends radially-outwardly from the base 261 relative to the central axis “Y”. An annular tab 264 is fixed to the distal edge 263b of the wall 263. The annular tab 264 is configured to sit in a cooperatively-shaped annular groove formed at the interface 232c of the housing bodies 232a, 232b to more securely fix the diaphragm 260 between the housing bodies 232a, 232b. In one preferred embodiment, the tab 264 has an arrowhead shape as best seen in FIG. 10. In other preferred embodiments, the tab 264 may have other cross-sectional profiles such as square, round or other shapes that are thicker than the nominal thickness of the wall 263.

The wall 263 includes a plurality of annular creases 268 proximate the distal edge 263b. As described below, the creases 268 enable the diaphragm 260 to fold and unfold about the creases 268 to change its orientation during oscillation of the pump as best seen in FIGS. 18-21.

The diaphragm support 265 is affixed to the bottom side of the central base 261 with reference to the orientation shown in FIGS. 7-10. In one preferred embodiment, the diaphragm support 265 includes a central, disc-shaped base 266 aligned co-axially with the central axis “Y”. A plurality of ribs 259 are fixed to the bottom of the central base 265. In the embodiment shown in FIG. 12, the base 261 includes radially-extending ribs 259a and co-axial, annularly-extending ribs 259b, which add rigidity to the central base 261.

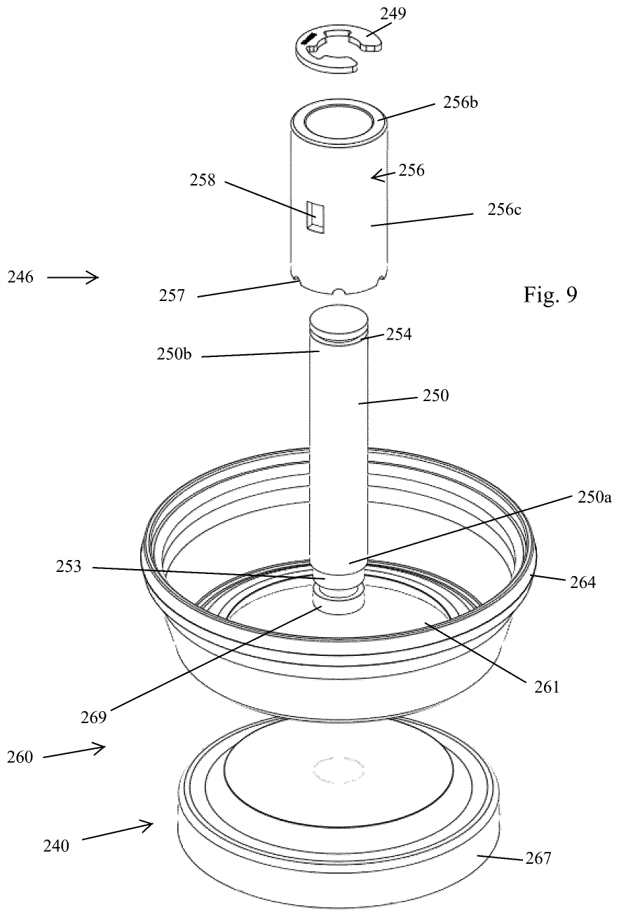

An annular, axially-extending wall 267 is fixed at its proximal edge 267a to the perimeter of the base 261 as best seen in FIGS. 9 and 10. In one preferred embodiment, the wall 267 has the shape of an endless ribbon and is centered around the central axis “Y”.

The diaphragm support 265 is preferably made from a material that is harder and more rigid than the diaphragm 260 to provide a solid and more durable surface on which a compression spring 262 (described below) impinges during oscillation of the pump. The diaphragm support 265 also adds diaphragm-orientation stability and ensures the diaphragm stem moves up/down consistently as the diaphragm 260 oscillates and rolls within the internal pump chamber 235.

In one preferred embodiment, the diaphragm assembly 240 includes a guide assembly 260 fixed to the diaphragm assembly 240. The guide assembly 246 keeps the central base 261 of the diaphragm assembly oriented generally perpendicular to the central axis “Y” so that the diaphragm walls roll generally symmetrically throughout the stroke cycle.

In the preferred embodiment shown in FIGS. 3-21, the guide assembly 246 comprises a guide stem 250 and a bushing 256. The guide stem oscillates within a cylinder 251 formed in the top housing body 232a. The guide stem 250 has a generally cylindrical shape with a reduced-diameter undercut 253 formed at the proximal end 250a, and a circumferential groove 254 formed at the distal end 250b. The undercut 253 is sized so that it can be inserted into and fixed to the mounting hub 269 of the diaphragm 260.

The bushing 256 has an inner diameter slightly larger than the outer diameter of the guide stem 250 so that air can flow along this annular gap G1 as described below. The length of the bushing 256 is shorter than the length of the guide stem 250. In one preferred embodiment, the bushing 256 is made of plastic. A plurality of ports 257 are formed in the proximal end wall 256a of the bushing 256 as best seen in FIGS. 7-9, which serve as passageways for air travelling down the annular gap G1 to escape the annular gap G1. In the embodiment shown in FIGS. 7-9, the ports 257 have a semi-circular profile and are equidistantly spaced around the circumference of the bushing 256.

A fluid communication channel is located in the bushing 256. In one preferred embodiment, the fluid communication channel comprises a notch 258 formed in the side wall 256c of the bushing 256 as seen in FIGS. 7-10. The notch 258 serves as a channel through which air can freely flow around one of the O-ring seals 248 in the cylinder 251 and surrounding the bushing 256 as best seen in FIG. 13. As described below, depending on the axial location of the bushing 256, the notch 258 straddles different O-ring seals 248 to bridge different portions of the fluid communications network of the control unit.

An E-ring 249 is seated in a circumferential groove 254 at the distal end of the guide stem 250. The outer diameter of the E-ring 249 is larger than the outer diameter of the guide stem 250 and slightly smaller than the inner diameter of the cylinder 251. The E-ring 249 engages the distal end 256b of the bushing 256 and urges the bushing 256 downward during one phase of the pump cycle as described below. In other preferred embodiments, the E-ring 249 comprises any mechanical protuberance connected to the distal end of the stem 250 that does not interfere with linear oscillation of the guide stem 250 but can actuate the bushing 256 downwardly.

As best seen in FIG. 13, the cylinder 251 extends axially through the top housing body 232a, has an inner diameter larger than the outer diameter of the bushing 256, and an axial length smaller than the length of the bushing 256 and guide stem 250. A plurality of O-ring seals 248a, 248b, 248c, 248d are seated in annular recesses spaced along the interior of the cylinder 251. In one preferred embodiment, the O-ring seals 248 are generally-equally spaced along the cylinder 251. The distance between O-ring seals 248 should be selected to allow the notch 258 in the bushing 256 to straddle each O-ring seal 248 and create a temporary fluid flow passage around the O-ring seal 248.

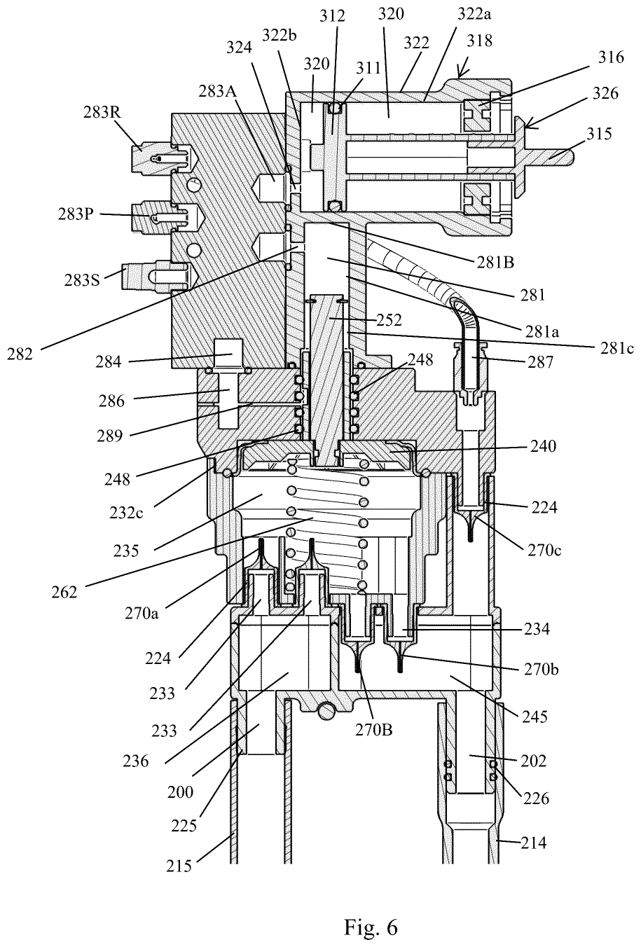

A compression spring 262 is seated in the bottom receiving chamber 235b in contact with the bottom of the diaphragm support 265. The compression spring 262 biases the diaphragm assembly 240 upwardly into the top limit position (home position) in contact with the base of top air chamber 235a as best seen in FIGS. 6 and 18. The compression spring 262 is also configured to allow the diaphragm assembly 240 to translate downwardly to the bottom limit position (extended position) in contact with a shoulder in the sidewall of the bottom receiving chamber 235b as best seen in FIG. 20.

A piston cavity 281 is formed on top of the top housing body 232a. Referring to FIG. 6, in one preferred embodiment, the piston cavity 281 has an elongate, cylindrical shape with a cylindrical sidewall 281a, a closed, axial end 281b, and an open, axial end 281c, which is contiguous and coaxial with the cylinder 251. A port 282 extends through the sidewall 281a in fluid communication with the air control valve 280 described below. The diameter of the piston cavity 281 is large enough so that guide stem 250 can freely translate upwardly and downwardly within the piston cavity 281 during the pump cycle.

The bottom of the pump housing 232 includes an inlet reservoir 236 where liquid mix is temporarily stored, and a pressure chamber 245 where pressurized air is infused into the liquid mix. The inlet reservoir 236 is connected in fluid communication with one of the mixture hoppers 216 by an inlet tube 215. The inlet tube 215 is connected at a proximal end to a reservoir inlet port 200 on the housing. In one preferred embodiment, the distal end of the inlet tube 215 has an inlet screen (not shown), which is submerged in one of the mixture hoppers 216 for drawing liquid mix. The pressure chamber 245 is connected in fluid communication with the freezing chamber by an outlet tube 214. The outlet tube 214 is connected at a proximal end to a freezing chamber outlet port 202 on the housing. The distal end of the outlet tube 214 is connected to the freezing chamber of the frozen dessert machine (not shown). In preferred embodiments, the inlet tube 215 and outlet tube 214 are mounted on barbed connectors 204, 206 surrounding the ports 200, 202, respectively. The barbed connectors 225, 226 are configured to allow easy connection and disconnection of the tubes 215, 214, respectively, during cleaning. Other quick connect/disconnect means may be provided for connecting the valves to the ports.

The pump chamber 235 includes one or more inlet ports 233, which connect the inlet reservoir 236 in fluid communication with the bottom receiving chamber 235b. The bottom receiving chamber 235b also includes one or more outlet ports 234, which connect the bottom receiving chamber 235b in fluid communication with the pressure chamber 245. Flexible one-way valves 270a, 270b are mounted on each inlet port 233 and outlet port 234, respectively. The valves 270a on the inlet ports 233 are configured to only allow one-way flow of liquid mix from the inlet reservoir 236 into the receiving chamber 235b, which occurs on the pump upstroke. The valves 270b on the outlet ports 234 are configured to only allow one-way flow of liquid mix from the receiving chamber 235b into the pressure chamber 245, which occurs on the pump downstroke. As will be described in more detail hereinafter, when the diaphragm assembly 240 moves toward the extended position, the liquid mix within the bottom receiving chamber 235b is pressurized and driven through the pressure outlet ports 234 and into the pressure chamber 245. The valves 270a on the mixture inlet ports 233 prevent pressurized fluid from passing to the inlet reservoir 236 and all of the pressurized fluid is delivered to the pressure chamber 245. Conversely, when the diaphragm assembly 240 moves in the opposite direction toward the home position, a vacuum is created in the receiving chamber 235b, thereby causing liquid mix to be drawn in through the mixture inlet ports 233. Due to the one-way valves 270b on the outlet ports 234, the vacuum force impacts only the reservoir 236 and not the pressure chamber 245.

In preferred embodiments, the one-way valves 270 are mounted on barbed connectors 224 surrounding the ports 233, 234. The barbed connectors 224 are configured to allow easy connection and disconnection of the valves 270 during cleaning. Other quick connect/disconnect means may be provided for connecting the valves to the ports.

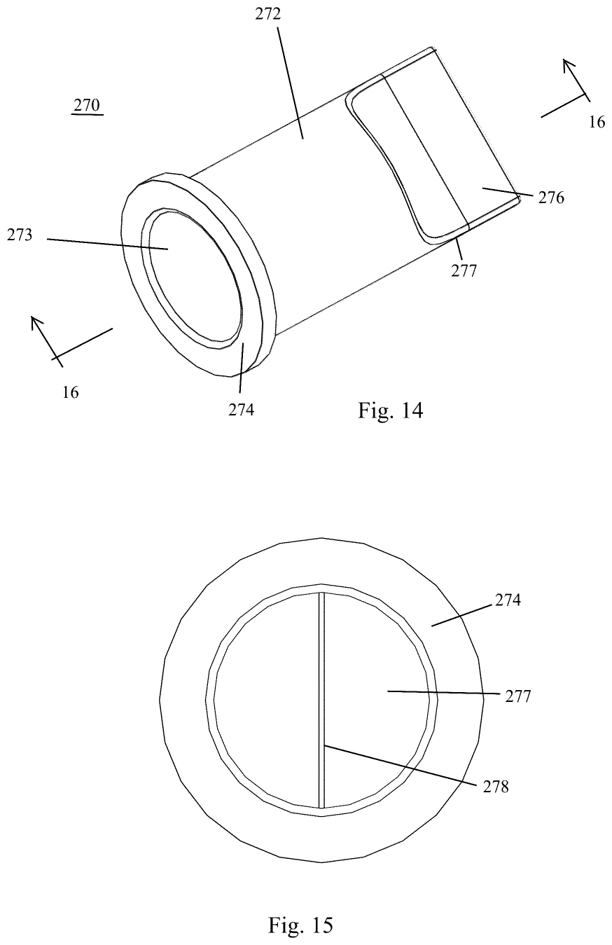

A one-way valve 270 in accordance with one preferred embodiment of the invention is shown in FIGS. 14-16. The valve 270 is preferably made from an elastomeric material. The valve 270 has a tubular body portion 272 and a check-valve portion 276 with an opening 273 at a first end and a closed second end. A flange 274 extends about the open end. The tubular body 272 includes a side wall 271 and an end wall 275. The opening 273 and interior dimensions of the tubular body 272 are configured to install over the barbed connectors 224, which provide support for the valve 270 and prevent it from inverting or tearing when pressure from the pump is applied to it. This support system greatly extends the life of the valve 270 and increases the effectiveness of the one-way function of the valve.

The check-valve portion 276 is formed contiguously with the end wall 275 and has the shape of a duck bill. The check valve 276 has converging, tapered flaps 277 and a planar slot 278 that extends coaxially with the tubular body. Other one-way valve configurations with a large slot opening may be utilized. With the tapered flap configuration, a liquid force directed on the outer surface of the flaps 277 causes the slot 278 to be forced into a sealed condition. When a liquid force passes through the opening 273, the force causes the flaps 277 to move apart and to open the slot 78. The flexible nature of the valve 270 and the wide slot 78 allows the valves to be tolerant to small particles in the liquid mix (like strawberry seeds, fruit pieces, etc) which greatly extends the types and flavors of liquid mix that can be used to make frozen dessert. The design of the one-way valve 270 also tolerates a significant amount of butterfat buildup without reducing its effectiveness as a one-way valve.

The use of flexible, one-way valves 270 with a large slot opening for pumping liquid mix and air reduces the complexity and number of parts associated with the pump. This enhancement provides benefits by reducing the cost of manufacturing the pump and it simplifies the routine cleaning procedure for the operator because there are less parts to disassemble, clean and reassemble.

As described above, the pump 231 operates between home and extended limit positions shown in FIGS. 18 and 20, respectively. Reciprocation of the diaphragm assembly is controlled by cyclically admitting pressurized air into the top air chamber 235a and then exhausting the air from the top air chamber 235a as described below.

Referring to FIGS. 2 and 3, an airflow valve 290 is connected to a compressor or other source of pressurized air “P” (not shown). The airflow valve 290 opens and closes to enable and disable, respectively, the flow of pressurized air to the pump assembly 230. The airflow valve 290 includes a body 292 with an input 294 and an outlet 296 port. The input port 294 connects to a compressor (not shown), which delivers air at a constant pressure, for example, 45 psi. The input of pressurized air from the compressor is identified by reference letter “P” in FIG. 3. A valve (not shown) within the airflow valve 280 controls the flow of air from the input 294 to the outlet 296. An adjustment screw 298 extends from the valve body 292 and allows a user to control the position of the valve to achieve a desired flow rate exiting through the air outlet 296. In preferred embodiments, the airflow valve 290 is located outside the pump cover 219 to allow easy adjustment of the airflow volume exiting the air outlet 296.

The airflow valve 290 is connected in fluid communication with the air control valve 280 by a tube 297. Air travels through a tube 297 to the air control valve 280, which selectively connects the air pressure source in fluid communication with the piston cavity 281, overrun chamber 418, pressure chamber 245, and/or the atmosphere depending on the condition (activated or deactivated) of the control valve 280 described below.

The pump assembly 230 includes an overrun unit 318, which helps to maintain a constant flow of air to the pressure chamber 245 as the speed of the pump varies. The overrun unit 318 generally comprises a housing 322 defining an internal chamber 320. Referring to FIGS. 6 and 17, the overrun housing 322 has cylindrical sidewalls 322a, a closed axial end 322b, and an open axial end 322c. In one preferred embodiment, the overrun housing 322 is formed integral with the upper portion of the pump housing 232, but may be otherwise positioned.

A port 324 extends through the closed axial end 322b and aligns with an external port 283R of the control valve 280, described below. The open axial end 322c is sealed with an overrun-chamber, volume-adjustment mechanism 326. In one preferred embodiment, the volume-adjustment mechanism 326 comprises an adjustment screw 310 having a threaded shaft 314 and a head 312 that has a size and shape that approximates the size and shape of a cross-section of the overrun chamber 320. In one preferred embodiment where the overrun chamber 320 is cylindrical, the head 312 is also cylindrical and has an outer diameter slightly less than the inner diameter of the overrun chamber 320. An O-ring 311 seal or the like seals between the head 312 and the sidewalls 322a of the overrun housing 322.

The threaded shaft 314 of the adjustment screw 310 extends through a threaded washer 316 positioned within the housing 322 proximate the open end 322c. In the illustrated embodiment, the washer 316 sits on a shoulder formed in the sidewalls 322a and is held in place by a snap ring 317 sitting in an annular groove extending around the inner periphery of the sidewalls 322a. A thumb knob 315 is fixed to the end of the threaded shaft 314, which enables an operator to comfortably rotate the adjustment screw 310. In other embodiments, a slot at the free end of the adjustment screw may be provided for engagement with a screwdriver or the like. In one preferred embodiment shown in FIG. 17, the threaded shaft 314 has flat surfaces 328 on which positioning indicia are printed, stamped or otherwise applied, which indicate the volume of the overrun chamber 320. By adjusting the volume of the overrun chamber 118, which is in fluid communication with the control valve 280, a user can control the amount of air delivered to the pressure chamber 245.

The control valve 280 has five external ports 283A, 283B, 283R, 283P, and 283S, an internal pilot stem (not shown), and an internal fluid communication network (not shown). The control valve 280 is configurable to two positions, namely, a home position and an extended position, by moving the internal pilot stem between first and second limit positions, respectively. An internal spring normally biases the pilot stem to the first position. The control valve 280 is actuated from the home position to the extended position by selectively applying positive air pressure to the input port of the pilot valve. Upon removal of the positive air pressure, the pilot stem returns to the home position due to the force of the spring.

As the control valve 280 changes from one position to the other, the fluid communication network between the external ports 283 changes. For example, in the preferred embodiment shown in FIG. 6, when the control valve 280 is configured in the home position (deactivated), the fluid communication network is configured as follows: port 283P is connected to port 283A; port 283S is connected to port 283B; and port 283R is closed. In the home position, port 283P is also connected to the control valve pilot stem 284 only if the side notch 258 in the bushing 256 bridges a gap in the fluid communication pathway between them as described below.

When the control valve 280 is configured in the extended position (activated), the fluid communication network is configured as follows: port 283P is connected to port 283B; port 283A is connected to port 283R; and, port 283S is closed. The control valve 280 controls operation of the pump assembly 230 as it cycles between the home and extended positions.

The five fluid flow ports 283 of the control valve 280 are connected in fluid communication to various components of the pump assembly through the valve internal communication network and one or more external fluid communication tubes. As described below, the terms “externally” means that the port is connected in fluid communication on the outside of the control valve 280 while “internally” means the port is connected via the internal fluid communication network inside the control valve 280.

Externally, the pressure supply port 283P is connected to the airflow valve 290 by a connection tube 297. Internally, depending on the position of the control valve 280 and position of the diaphragm assembly 240, the pressure supply port 283P is connected via the communication network to the overrun chamber 322 or the piston cavity 281, and/or the pilot stem.

Externally, the pressure chamber supply port 283R is connected to the pressure chamber 245 by a connection tube 287. Internally, depending on the position of the control valve 280, the pressure chamber supply port 283R is connected to the pressure chamber 245 or closed.

Externally, the overrun chamber supply port 283A is connected to the overrun unit 318. Internally, depending on the position of the control valve 280, the overrun chamber supply port 283A is connected to the pressure supply port 283P or pressure chamber supply port 283R.

Externally, the piston cavity supply port 283B is connected to the piston cavity 281. Internally, depending on the position of the control valve 280, the piston cavity supply port 283 is connected to the vent port 283S or the pressure supply port 283P.

Externally, the vent port 283S connects to the external atmosphere. Internally, depending on the position of the control valve 280, the vent port 283S is connected to the piston cavity supply port 283B or closed.

The pumping assembly 230 is powered by compressed air flowing from a compressor or other compressed air source that is connected to the airflow valve 290. The pump assembly 230 is turned on and off by opening and closing the airflow valve 290, and is actuated when frozen dessert is dispensed from the associated freezing chamber. The pump assembly operates between a home position and an extended position, as described below with reference to FIGS. 18-21.

The pump assembly is off and deactivated when the airflow valve 290 is closed. When the pump is off, the air control valve 280 is configured in the home position as described above. Port 283P is connected to port 283A, and port 283B is connected to port 283S; however, there is no air flow between the ports. Port 283R is closed. There is no pressure in the overrun chamber 320 or the piston cavity. The diaphragm assembly 240 is configured in its home position with the diaphragm 260 pushed upwardly by the compression spring 262 in abutment with the top end wall 237 of the internal pump chamber 235. In this position, the top air chamber 235a is collapsed to its minimum size with nearly all air expelled therefrom, while the bottom receiving chamber 235b is expanded to its maximum size. This configuration defines the home position of the pumping assembly 230.

When the airflow control valve 290 is turned on, pressurized air flows into the control valve 280 through the pressure supply port 283P. Air flows from the pressure supply port 283P to the overrun chamber 320 through the overrun chamber supply port 283A. At the same time, air flows through an internal conduit 288 in the air control valve 280, through a conduit 289 in the top housing body 232a, and into a cavity 286 adjacent the pilot stem 284. Air flow from the internal pressure conduit 288 to the pilot stem conduit 289 is only possible when the bushing is in this home position. In this position, the side notch 258 in the bushing 256 straddles the second O-ring seal 248b and creates a temporary air flow pathway bridging the pressure conduit 288 and pilot conduit 289 as best seen in FIG. 18. Later in the pump cycle when the bushing 256 translates downward, the side notch 258 moves out of fluid alignment with the conduits 288, 289, which then become isolated.

When the air pressure exceeds a defined limit in the cavity 286, the pilot stem 284 actuates from the home position to the extended position. When this occurs, the port connections within the control valve 280 change as described above. Pressurized air from port 283P now flows into the piston cavity 281 through port 283B. Air within the piston cavity 281 flows downward through the annular gap “G1” between the outer diameter of the diaphragm guide stem 250 and the inner diameter of the bushing 256 and into the top air chamber 235a. As air pressure builds in the top air chamber 235a, the diaphragm 260 is pushed downward against the bias of the spring 262 as shown in FIG. 19. Downward movement of the diaphragm 260 causes liquid mix within the inlet reservoir 236 (after equilibrium in the pump cycle) to be expelled through the one-way valves 270b into the pressure chamber 245.

When the pilot stem 284 actuates to the extended position, port 283A is connected to port R, and pressurized air in the overrun chamber 320 discharges and flows through the tube 287, through the one-way valve 270c, and into the pressure chamber 245. In the initial phase of downward movement of the diaphragm 260 and guide stem 250, the bushing 256 remains in the same home position as shown in FIG. 18. Movement of the bushing 256 is inhibited by the friction force of the O-ring seals 248 abutting its outer surface. The notch 258 continues to bridge the pressure conduit 288 and pilot conduit 289 to maintain pressure in the pilot cavity 286, which maintains the pilot stem 284 in the extended position.

As pressure in the top air chamber 235 continues to build, the diaphragm 260 and diaphragm assembly 260 continue downward movement until the distal edge 267b of the annular wall 267 of the diaphragm support 265 abuts a shoulder in the internal pump chamber 235. Prior to reaching this position, the E-ring 249 abuts the top end of the bushing 256 and pulls the bushing 256 downward to the position shown in FIG. 20. This configuration defines the extended position of the diaphragm assembly 240. In this position, the notch 258 no longer straddles the second O-ring seal 248b or bridges the conduits 288, 289. Instead, the notch straddles the third O-ring seal 248c, and bridges the pilot stem conduit 289 and vent conduit 279, which allows the pressurized air in the pilot cavity 286 to vent to atmosphere and return the pilot stem 284 to the home position.

When the pilot stem 284 deactivates and returns to the home position, the control valve 280 returns to the home position. Pressurized air no longer enters the top air chamber 235a. Instead, pressurized air within the top air chamber 235a vents upwardly through the gap G1 around the guide stem 250, through the stem cavity 281, through the supply port 283B, and out the vent port 283S. As that air vents and reduces the force on the top of the diaphragm 260, the compression spring 262 urges the diaphragm assembly 240 upward, which creates a vacuum in the bottom receiving chamber 235b and draws liquid mix from the inlet reservoir 236 into the receiving chamber 235b through the one-way valves 270a.

As the diaphragm assembly 240 moves upward, the creases 268 in the diaphragm wall 263 allow the diaphragm 260 to roll or fold over itself, and reverse its orientation from concave to convex as best seen in FIG. 21. During an initial phase of the upstroke, the bushing 256 does not move from its extended position straddling O-ring seal 248c, which continues to allow the air in cavity 286 to vent out through the vent conduit 279. Then, at an intermediate phase of the upstroke shown in FIG. 21, the top of the diaphragm 260 abuts the bottom of the bushing 256. Thereafter, as the diaphragm assembly 240 moves upward, the diaphragm 260 pulls the bushing 256 upward and returns the bushing 256 to its home position shown in FIG. 18. When the diaphragm assembly 240 and bushing 256 return to their home positions, the pump assembly has returned to its home position to complete the pump cycle.

The above-described pump cycle only runs when the operator opens the dispense tap and allows frozen dessert to dispense from the freezing chamber, which is connected to and has the same pressure as the pressure chamber 245. When the dispense lever or tap is closed, the pressure within the gas chamber 235a, piston cavity 281 and overrun chamber 320 is balanced by the pressure in the pressure chamber 245 and receiving chamber 235b plus the return force of the compression spring 262. Because there is no pressure differential, the pump does not cycle. When the dispense tap is opened, the pressure in the pressure chamber 245 drops, which causes a pressure differential within the pump system, which causes the pump to cycle. The speed at which the pump cycles depends on the dispense rate. Higher dispense rates cause the pump to cycle faster, while lower dispense rates cause the pump to cycle slower. However, because the pressure of the airflow from the overrun unit is constant, the pressure in the pressure chamber and percentage of infused air into the liquid dessert in the pressure chamber is constant and independent of the speed at which the pump cycles.

To dispense frozen dessert from the machine, the operator actuates the dispense tap, which in turn actuates the pump assembly as described above. The speed of the dispense is controlled by selectively controlling movement of the tap. A typical dispense pattern involves an initial slow dispense, followed by a fast dispense, then a final slow dispense. The air content of the ice cream dispensed from an ice cream machine incorporating the pumping assembly of the present invention does not vary depending on the dispense rate or operational speed of the pump. Instead, the infusion air pressure into the liquid dessert is constant because the source of that air infusion is the overrun chamber 320, which is connected directly to the compressed air source. After air dispenses from the overrun chamber 320 during the downstroke, it is immediately replaced on the upstroke when it disconnects from the pressure chamber 245 and re-connects to the pressure valve 283P, i.e., the compressor. The flow rate of air exiting the overrun chamber is equal to the flow rate of air exiting the pressure chamber, i.e., within the pressurized liquid dessert. Therefore, the pressure of the pressure chamber remains constant no matter how fast or slow the ice cream is dispensed.

The constant pressure system also allows soft serve to be dispensed smoothly at high overrun rates, without air pockets that plague many mix pumps. The adjustable overrun air chamber also provides on-the-go overrun adjustments (e.g. 20%-85% overrun adjustment). Furthermore, the pump design automatically adjusts the flow rate based on the freezing chamber pressure of the machine, i.e., the pump runs at the speed necessary to maintain a constant freezing chamber pressure regardless of how fast the user is tapping ice cream. The pump system automatically controls the freezing chamber pressure without the use of a freezing chamber pressure sensor or pressure relief valve. This minimizes the foam that is normally created in the liquid mix hopper from bypassed liquid/air.

The volume of the overrun chamber 320 can be changed by turning the volume adjustment mechanism 326 to increase or decrease the chamber volume. However, once set by the operator, the volume of air infused into the pressure chamber 245 per cycle stroke remains constant because that volume is defined by the volume of the pressure chamber 320.

These and other advantages of the present invention will be apparent to those skilled in the art from the foregoing specification. Accordingly, it will be recognized by those skilled in the art that changes or modifications may be made to the above-described embodiments without departing from the broad inventive concepts of the invention. It should therefore be understood that this invention is not limited to the particular embodiments described herein, but is intended to include all changes and modifications that are within the scope and spirit of the invention as defined in the claims.

1. A pump assembly for delivering liquid dessert to the freezing chamber of a soft serve machine where it is formed into frozen dessert, comprising:
a. a pump unit having a housing, an internal chamber, and a diaphragm assembly including a diaphragm extending across said internal chamber, said diaphragm dividing said internal chamber into a gas chamber on a first side of the diaphragm and a liquid mix receiving chamber on a second, opposite side of the diaphragm,
b. an overrun unit configured to receive pressurized air from an external pressure source;
c. a pressure chamber for receiving liquid dessert from said receiving chamber, combining the liquid dessert with pressurized air received from said overrun unit to form liquid dessert, and delivering the liquid dessert to the freezing chamber;
d. a control unit having a control valve and a fluid communications network that selectively connects an external source of pressurized air in fluid communication with said overrun unit, selectively connects said overrun unit in fluid communication with said gas chamber, selectively vents said gas chamber to atmosphere, and selectively connects said overrun unit to said pressure chamber;
wherein reciprocation of said diaphragm assembly is caused by alternately pressurizing said gas chamber with air and then venting air from said gas chamber to atmosphere; and,
wherein on the diaphragm assembly upstroke, liquid dessert is drawn into said receiving chamber from a reservoir, and on the diaphragm assembly downstroke, liquid dessert is expelled from the receiving chamber into the pressure chamber and pressurized air is expelled from the overrun unit into the pressure chamber to form liquid dessert in the pressure chamber.

2. The pump assembly recited in claim 1, wherein the volume of pressurized air delivered to said pressure chamber per stroke of said pump is constant over the operating range of dispense rates of frozen dessert from an associated freezing chamber.

3. The pump assembly recited in claim 1, wherein said overrun chamber supplies air to the pressure chamber at a constant pressure over the operating range of dispense rates of frozen dessert from an associated freezing chamber.

4. The pump assembly recited in claim 1, wherein a pressure within an associated freezing chamber is automatically maintained without the use of a freezing chamber pressure sensor or pressure relief valve.

5. The pump assembly recited in claim 1, wherein a speed of the pump automatically adjusts to maintain a constant freezing chamber pressure regardless of a dispense rate of frozen dessert from an associated freezing chamber.

6. The pump assembly recited in claim 1, wherein the pump is actuated when frozen dessert is dispensed from an associated freezing chamber.

7. The pump assembly recited in claim 6, wherein the speed of the pump is controlled by the dispense rate of frozen dessert from an associated freezing chamber.

8. The pump assembly recited in claim 1, wherein a valve permits only one-way fluid communication from said overrun unit to said pressure chamber, a valve permits only one-way fluid communication from said receiving chamber to said pressure chamber, and a valve permits only one-way fluid communication from a liquid dessert reservoir to said receiving chamber.

9. The pump assembly recited in claim 8, wherein each of said valves comprises a flexible, one-way valve having a duckbill configuration.

10. The pump assembly recited in claim 1, wherein the overrun adjustment chamber has an adjustable volume.

11. The pump assembly according to claim 10, wherein the volume of the overrun adjustment chamber is adjustable during operation of the diaphragm pump.

12. The pump assembly recited in claim 1, wherein said control unit is configured to receive gas of a desired pressure from a compressor in combination with a pressure regulator.

13. The pump assembly recited in claim 1, wherein said pressure chamber is defined within a pressure housing that is releasably attached to said diaphragm pump.

14. The pump assembly recited in claim 1, wherein said diaphragm assembly operates between a home position and extended limit position.

15. The pump assembly recited in claim 14, including a spring that urges said diaphragm assembly to the home position.

16. The pump assembly recited in claim 14, wherein the volume of said gas chamber is minimized and the volume of said receiving chamber being maximized when said diaphragm assembly is located in the home position, and wherein the volume of said gas chamber is maximized and the volume of said receiving chamber is minimized when said diaphragm assembly is located in said extended position.

17. The pump assembly recited in claim 1, wherein said diaphragm assembly includes a guide assembly comprising a guide stem connected to said diaphragm and a bushing surrounding said guide stem.

18. The pump assembly recited in claim 17, wherein said guide assembly oscillates in a cylinder formed in said pump housing.

19. The pump assembly recited in claim 1, wherein said bushing includes a fluid communication channel that selectively connects with different portions of the fluid communications network of said control unit.

20. The pump assembly according to claim 17, wherein a gas passage to and from the gas chamber is defined between said guide stem and said bushing.
